(19) United States
(12) Patent Application Publication
(10) Pub. No.: US 2002/0125112 A1
(43) Pub. Date: Sep. 12, 2002

(54) Four-direction switch device

(75) Inventor: Keiji Takezawa, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/087,312

(22) Filed: Mar. 1, 2002

(30) Foreign Application Priority Data
Mar. 6, 2001 (JP) 2001-061467

(51) Int. Cl. H01H 25/04

(52) U.S. Cl. 200/6 A

(57) ABSTRACT

A four-direction switch device of the present invention comprises: a case; pushbutton switches housed in the case; and one operation member that is supported by the case to be tiltable in four directions of a cross shape and operates the pushbutton switches by tilt operations in the respective directions, wherein the operation member can tilt to first and second tilt positions that are opposite to each other with respect to a tilt center, and third and fourth tilt positions that are orthogonal to the first and second tilt positions and are opposite to each other with respect to the tilt center, and has operation power increasing means for producing greater operation power for a tilt to the fourth tilt position than for tilts to the first, second, and third tilt positions during tilt operations on the operation member.

### BACKGROUND OF THE INVENTION

1. Field of the Invention

The present invention relates to a four-direction switch device suitably used for a vehicle keyless entry device.

2. Description of the Prior Art

Drawings of a conventional four-direction switch device are described below. FIG. 6 is a plan view showing a conventional four-direction switch device. FIG. 7 is a sectional view taken along the line 7-7 of FIG. 6.

A box-shaped upper case 51 made of a synthetic resin material has an upper wall 51a, a side wall 51b which is elongated almost vertically from an outer circumferential edge of the upper wall 51a and surrounds the switch device, and a through hole 51c provided at a nearly central portion of the upper wall 51a.

A holding member 52 made of a synthetic resin material is formed into the shape of a nearly square flat plate and four rectangular through holes 52a are formed in positions of a cross shape toward four outer circumferential sides from the central position of the holding member 52. The holding member 52 is fastened within the through hole 51c of the upper case by a proper means to block the through hole 51c.

Plural (four) operation knobs 53 made of a synthetic resin material are in the shape of a nearly rectangular flat plate, and on the surfaces of the respective operation knobs 53 are drawn icons 53a indicating specific operations such as a door open indication symbol, a door lock indication symbol, a trunk open indication symbol, and a panic operation indication symbol. The four operation knobs 53 are disposed within the four through holes 52a. The respective icons 53a are drawn one for each of the operation knobs 53. On the back of the operation knobs 53 is formed an engaging part 53b protruding outward.

An elastic cover 54 made of an elastic rubber material, which is similar to a dome in shape, has an upper wall 54a, a side wall 54b elongated curvedly from an outer circumferential edge of the upper wall 54a downward, flanges 54c protruded orthogonally to the side wall 54b from an open end thereof, four engaging parts 54d protruding from an outer surface of the upper wall 54a outward and provided in positions of a cross shape, and four pressing parts 54e protruding from an inner surface of the upper wall 54a inward and provided in positions respectively opposite to the four engaging parts 54d.

To the engaging parts 54d of the elastic cover 54, engaging parts 53b of the operation knobs 53 are coupled by such a proper means as snaps in a snap leg (not shown) provided on the engaging parts 54d in an indention (not shown) of the operation knobs 53. By this coupling, the operation knobs 53 are attached to the elastic cover 54.

A pushbutton switch 55 has a box-shaped housing 55a housing a movable contact (not shown), a fixed contact (not shown), and the like, and a pushbutton 55b provided protrusively from the upper surface of the housing 55a outward under pressure of the movable contact (not shown) and a spring member (not shown). Four of the pushbutton switches 55 are disposed, and the respective pushbuttons 55b of the pushbutton switches 55 have a nearly equal press operation power by dint of the movable contact (not shown) and the spring members (not shown).

The four pushbutton switches 55 are disposed opposite to the four pressing parts 54e of the elastic cover 54.

A printed wiring board 56 is in the shape of a nearly rectangle flat plate, and on the surface of the printed wiring board 56 is formed a required circuit pattern (not shown). On the printed wiring board 56 are disposed in positions of a cross shape the four pushbutton switches 55.

The printed wiring board 56 and the pushbutton switches 55 are housed within the elastic cover 54.

A box-shaped lower case 57 made of a synthetic resin material has a nearly rectangular bottom wall 57a, a side wall 57b which is elongated almost vertically from an outer circumferential edge of the bottom 57a and surrounds the switch device, and steps 57c provided at open ends of the side wall 57b. The lower case 57 and the upper case 51 are integrally incorporated with the flanges 54c of the elastic cover 54 being interposed therebetween.

Next, the operation of the conventional four-direction switch device is described.

First, when a required press power is applied to one operation knob 53 on which an icon 53a indicating a specific operation is drawn, the operation knob 53 is moved downward by the press power, and the elastic cover 54 is distorted at one location by the movement. By the pressing parts 54e of the distorted elastic cover 54, the pushbutton 55b of one pushbutton switch 55 is operated against a movable contact and a spring member and the pushbutton switch 55 goes on. During this operation, operation power by the moving contact and the spring member in one pushbutton switch 55 and operation power of the elastic cover 54 by distortion at one location together enable the operation knob 53 to be operated with a small press power.

When the press power to the operation knob 53 is removed, the operation knob 53 returns to its original position by the self-return force of the pushbutton 55b of the pushbutton switch 55 and the self-return force of the elastic cover 54, and the pushbutton switch 55 is turned off when the operation knob 53 returns to its original position.

When the operation knobs 53 on which the other three icons 53a are drawn are respectively applied with press power, the same operation as the above described operation in one pushbutton switch 53 is performed. Even by press power to any operation knob 53, the operation knob 53 can be operated with the same small press power by dint of operation power of one pushbutton switch 55 and operation power of the elastic cover 54 by distortion at one location. All press powers to the four operation knobs 53 are equalized.

In other words, in a normal condition, since press power of one pushbutton switch 55 operated by an operation knob 53 in which an icon 53a indicating the operation of a panic operation indication symbol is drawn is almost equal to press power of the pushbutton switches 55 respectively operated by the other three operation knobs 53 in which other icons 53a are drawn, the operation knob 53 in which the icon 53a indicating the operation of a panic operation indication symbol is drawn will be easily and carelessly operated.

As has been described above, in a conventional four-direction switch device, since press powers to the four operation knobs are almost equal, if an operation knob of panic operation is carelessly operated, such malfunctions that, for example, a horn is sounded or a light blinks are liable to occur.

### SUMMARY OF THE INVENTION

The present invention provides a four-direction switch device that is almost free of careless operations on operation knobs thereof.

A four-direction switch device of the present invention comprises: a case; plural pushbutton switches housed in the case; and one operation member that is supported by the case to be tiltable in four directions and operates the pushbutton switches by tilt operations in the respective directions, wherein the operation member can tilt to first and second tilt positions that are opposite to each other with respect to a tilt center, and third and fourth tilt positions that are orthogonal to the first and second tilt positions and are opposite to each other with respect to the tilt center, and the operation member has an operation power increasing means for producing greater operation power for a tilt to the fourth tilt position than for tilts to the first, second, and third tilt positions during tilt operations on the operation member.

With the construction, since tilt operation power to one tilt position of the operation member is grater than tilt operation power to other three tilt positions, there is a difference in the magnitude of tilt operation power, so that a four-direction switch device almost free of careless operations can be provided which can explicitly tell the operator a tilt position requiring the great tilt operation power.

The four-direction switch device of the present invention has first, second, and third pushbutton switches operated by the operation member, wherein one pushbutton switch is operated in each of the first, second, and third tilt positions, wherein two of the pushbutton switches are operated in the fourth tilt position, and wherein the operation power increasing means is constituted by operation power with which the two pushbutton switches are operated.

With the construction, since the four-direction switch device can be configured with three pushbutton switches, the number of parts can be reduced and the inexpensive four-direction switch device having a simple construction can be provided in which the operation power increasing means is constituted by operation power with which the two pushbutton switches are operated.

In the four-direction switch device of the present invention, the first pushbutton switch is placed on a line passing through the tilt center at a side of the third tilt position, the second pushbutton switch is placed in a middle position between the first tilt position and the fourth tilt position, the third pushbutton switch is placed in a middle position between the second tilt position and the fourth tilt position, when the operation member is operated to tilt to the fourth tilt position, the two second and third pushbutton switches are operated at the same time, and the operation power increasing means is constituted by operation power with which the two second and third pushbutton switches are operated.

By this construction, a four-direction switch device can be provided which enables three pushbutton switches to be operated without fail.

In the four-direction switch device of the present invention, each pushbutton switch is constructed to operate by dint of pressure opposing a press of a spring movable contact or/and a press of a spring member energizing the pushbutton, and the operation power increasing means is constituted by the pressure against the two pushbutton switches.

By this construction, since the operation power increasing means has a simple construction, the number of parts can be reduced and an inexpensive four-direction switch device can be provided.

In the four-direction switch device of the present invention, an elastic cover made from rubber is disposed to cover the pushbutton switches between the operation member and the plural pushbutton switches, the pushbutton switches are operated via the elastic cover by tilting the operation member, and during a fourth tilt operation, the elastic cover is formed to distort in at least two locations which are opposite to two pushbutton switches, to use the distortion of the elastic cover as the operation power increasing means.

By this construction, since the operation power increasing means has a simple construction, the number of parts can be reduced and further an inexpensive four-direction switch device can be provided.

The four-direction switch device of the present invention is constructed so that a panic operation is performed by operating the operation member for the fourth tilt operation, which is provided with the operation power increasing means. With this construction, a four-direction switch device almost free of careless panic operations can be provided.

### BRIEF DESCRIPTION OF THE DRAWINGS

FIG. 1 is a plan view showing a four-direction switch device of the present invention;

FIG. 2 relates to the four-direction switch device of the present invention and is a plan view showing a lower case, a printed wiring board, and pushbutton switches;

FIG. 3 is a sectional view taken along line 3-3 of FIG. 1;

FIG. 4 is a plan view showing a second embodiment of the four-direction switch device of the present invention;

FIG. 5 is a sectional view taken along the line 5-5 of FIG. 4;

FIG. 6 is a plan view showing a conventional four-direction switch device; and

FIG. 7 is a sectional view taken along the line 7-7 of FIG. 6.

### DESCRIPTION OF THE PREFERRED EMBODIMENTS

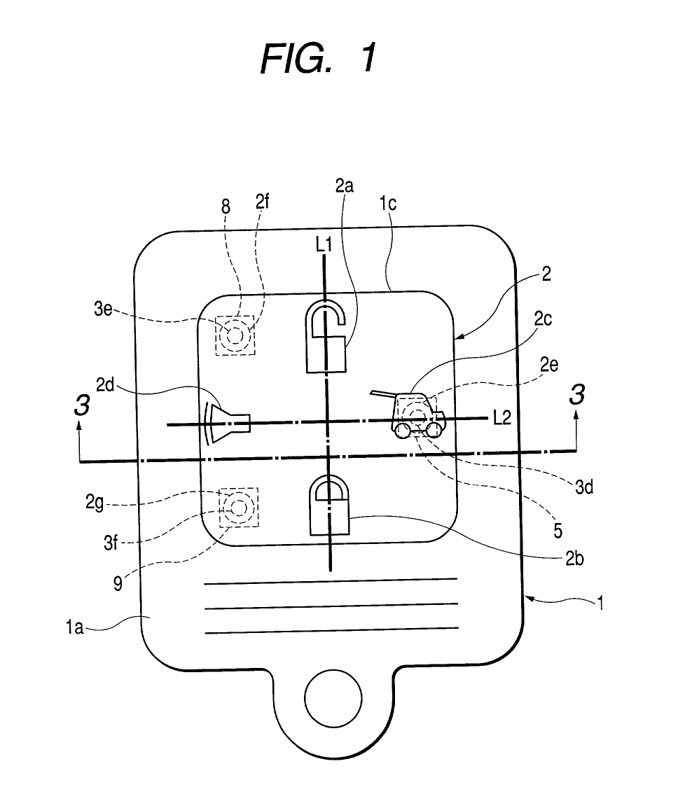

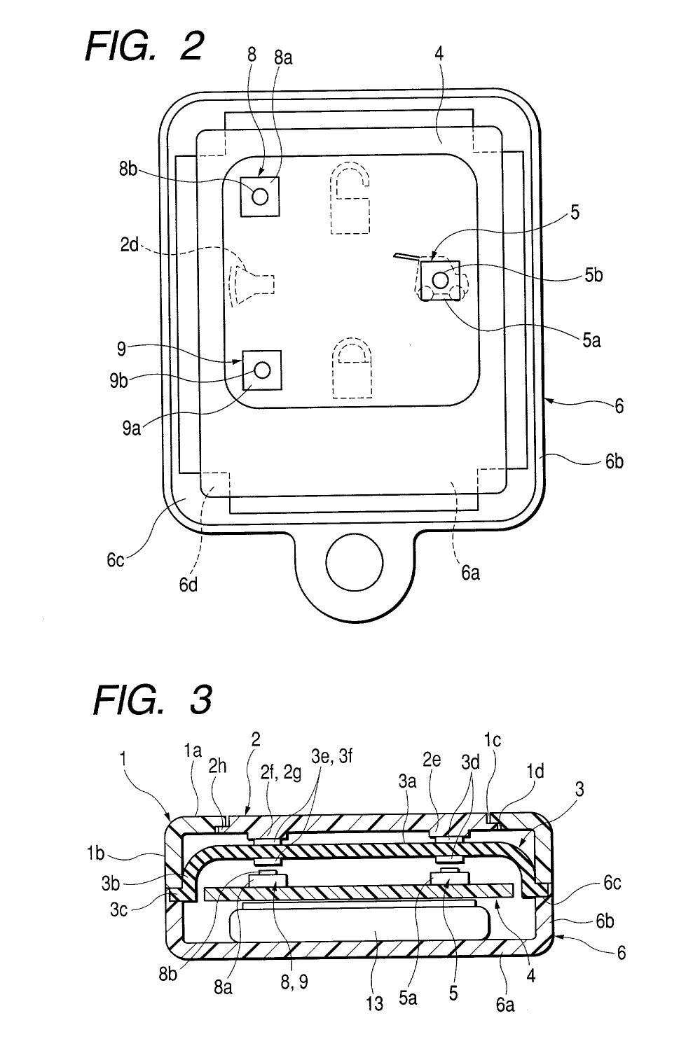

The following explains drawings on the four-direction switch device of the present invention. FIG. 1 is a plan view showing the four-direction switch device of the present invention. FIG. 2 relates to the four-direction switch device of the present invention and is a plan view showing a lower case, a printed wiring board, and pushbutton switches. FIG. 3 is a sectional view taken along line 3-3 in FIG. 1.

A box-shaped upper case 1 made of a synthetic resin material has a flat upper wall 1a, a side wall 1b which is elongated almost vertically from an outer circumferential edge of the upper wall 1a and surrounds the switch device, a nearly square through hole 1c provided at a nearly central portion of the upper wall 1a, and step 1d provided in an inner circumferential edge of the through hole 1c.

A box-shaped lower case 6 made of a synthetic resin material has a flat bottom wall 6a, a side wall 6b which is elongated almost vertically from an outer circumferential edge of the bottom 6a and surrounds the switch device, steps 6c provided in inner circumferential edges of open ends of the side wall 6b, and holding parts 6d that are at four corners of the side wall 6b and respectively protrude from the vicinity of the steps 6c inward.

End faces of the side wall 1b of the upper case 1 are abutted on end faces of the side wall 6b of the lower case 6 to constitute one housing.

A printed wiring board 4 is in the shape of a nearly rectangle flat plate, and on the surface of the printed wiring board 4 is formed a required circuit pattern (not shown).

The printed wiring board 4 is mounted by a proper means with the four corners of the printed wiring board 4 being disposed on the holding parts 6d of the lower case 6 and is housed in the housing.

The first, second, and third pushbutton switches 5, 8, and 9 respectively have box-shaped housings 5a, 8a, an 9a housing a movable contact (not shown), a fixed contact (not shown), and the like, an pushbuttons 5b, 8b, and 9b provided protrusively from the upper surfaces of the housings 5a, 8a, and 9a outward under pressure of the movable contact (not shown) and a spring member (not shown) The first, second, and third pushbutton switches 5, 8, and 9 are connected to and mounted at predetermined locations on the printed wiring board 4 by a proper means such as soldering.

The first, second, and third pushbutton switches 5, 8, and 9 are constructed to operate by dint of pressure opposing a press of a spring movable contact (not shown) or/and a press of a spring member (not shown) energizing the pushbuttons 5b, 8b, and 9b. Therefore, the pushbuttons 5b, 8b, and 9b are operated vertically by dint of pressure opposing a press of the movable contact or/and a press of a spring member energizing the pushbuttons 5b, 8b, and 9b.

An elastic cover 3 made of an elastic rubber material, which is similar to a dome in shape, has a flat upper wall 3a, a side wall 3b elongated curvedly from an outer circumferential edge of the upper wall 3a downward, flanges 3c protruded orthogonally to the side wall 3b from an open end thereof, and first, second, and third pressing parts 3d, 3e, and 3f that respectively protrude outward and downward at opposite positions on an outer surface and an inner surface of the upper wall 3a, wherein the first, second, and third pressing parts 3d, 3e, and 3f are respectively placed at the vertexes of a rough triangle.

The elastic cover 3 is housed in the upper case 1, where the first, second, and third pressing parts 3d, 3e, and 3f are placed to be opposite to the first, second, and third pushbutton switches 5, 8, and 9.

The elastic cover 3 covers the printed wiring board 4, and the first, second, and third pushbutton switches 5, 8, and 9 housed therein.

When the first, second, and third pressing parts 3d, 3e, and 3f of the elastic cover 3 are distorted, the corresponding first, second, and third pushbutton switches 5, 8, and 9 are operated.

An operation member 2 made of a synthetic resin material, which is in the shape of a nearly square flat plate, has icons indicating specific operations, drawn in positions of a cross shape (four directions) on one face (surface) thereof. The icons include, for example, a first icon 2a indicating a door open indication symbol, a second icon 2b indicating a door lock indication symbol, a third icon 2c indicating a trunk open indication symbol, and a fourth icon 2d indicating a panic operation indication symbol.

The first icon 2a and the second icon 2b are placed to be opposite to each other on a first line L1 passing through the center of the operation member 2, and the third icon 2c and the fourth icon 2d are placed to be opposite to each other on a second line L2 that is orthogonal to the first line L1 and passes through the center of the operation member 2.

On another face (back) of the operation member 2 are formed: a first protrusion 2e that faces the third icon 2c and protrudes downward in the vicinity of one side of an outer circumferential edge of the operation member 2; a second protrusion 2f that protrudes downward in the vicinity of one corner of the outer circumferential edge of the operation member 2 between the first icon 2a and the fourth icon 2d; and a third protrusion 2g that protrudes downward in the vicinity of one corner of the outer circumferential edge of the operation member 2 between the second icon 2b and the fourth icon 2d.

In other words, the first, second, and third protrusions 2e, 2f, and 2g are placed to be respectively at the vertexes of a rough triangle, and are placed to be opposite to the first, second, and third pressing parts 3d, 3e, and 3f of the elastic cover 3. When the first, second, and third protrusions 2e, 2f, and 2g are operated downward in this state, the first, second, and third pressing parts 3d, 3e, and 3f of the elastic cover 3 are pressed by the first, second, and third protrusions 2e, 2f, and 2g.

A flange 2h surrounding the outer circumferential thereof is formed in an outer circumferential edge of the operation member 2. The operation member 2 is disposed in the through hole 1c of the upper case 1 so that the flange 2h of the operation member 2 is housed and supported in the step id provided in an inner circumferential edge of the through hole 1c. By this construction, the operation member 2 is supported by the upper case 1 to be tiltable in four directions of a cross shape and capable of tilt operations in individual directions.

The first, second, and third pushbutton switches 5, 8, and 9 on the printed wiring board 4 are placed to be opposite to the first, second, and third pressing parts 3d, 3e, and 3f of the elastic cover 3 so that the first, second, and third pressing parts 3d, 3e, and 3f can respectively operate the first, second, and third pushbutton switches 5, 8, and 9 by dint of a distortion operation of the elastic cover 3.

Specifically, the first pushbutton switch 5 is opposite to the first pressing part 3d of the elastic cover 3, the second pushbutton switch 8 is opposite to the first pressing part 3e of the elastic cover 3, and the third pushbutton switch 9 is opposite to the first pressing part 3f of the elastic cover 3.

That is, the first, second, and third pushbutton switches 5, 8, and 9 are disposed to be respectively opposite to the first, second, and third protrusions 2e, 2f, and 2g of the operation member 2.

The flange 3c of the elastic cover 3 is mounted on the steps 6c of the side wall 6b of the lower case 6, and the side wall 1b of the upper case 1 is placed on the side wall 6b of the lower case 6 with the flanges 3c of the elastic cover 3 sandwiched between the side wall 1b and the steps 6c. Thereby, the elastic cover 3 is housed within the upper and lower cases 1 and 6 in such a manner that the upper case 1 and the lower case 6 sandwich the elastic cover 3.

A button battery 13 has a specified voltage value and is housed in the lower case 6.

The operation of the four-direction switch device of the present invention is described.

As a first tilt operation, when the first icon 2a (first tilt position) indicating a door open indication symbol drawn on the operation member 2 is pressed, the operation member 2 is tilted in a direction of the first icon 2a with respect to a tilt center. By this tilt operation, the second protrusion 2f of the operation member 2 operates the second pushbutton switch 8 via the second pressing part 3e of the elastic cover 3. The tilt operation power at this time is operation power caused by distortion at one location of the elastic cover 3 and pressure opposing a press of a spring movable contact (not shown) of the second pushbutton switch 8 or/and a press of a spring member (not shown) energizing the pushbutton 8b. The operation member 2 is tilted by the small tilt operation power.

When the press to the first icon 2a is removed, the operation member 2 returns to its original position parallel to the upper case 1 by pressure opposing the press of the spring movable contact (not shown) of the second pushbutton switch 8 or/and the press of the spring member (not shown) energizing the pushbutton 8b, and a self-return force of the elastic cover 3.

As a second tilt operation, when the second icon 2b (second tilt position) indicating a door lock indication symbol drawn on the operation member 2 is pressed, the operation member 2 is tilted in a direction of the second icon 2b.

By this tilt operation, the third protrusion 2g of the operation member 2 operates the third pushbutton switch 9 via the third pressing part 3f of the elastic cover 3. The tilt operation power at this time is operation power caused by distortion at one location of the elastic cover 3 and pressure opposing a press of a spring movable contact (not shown) of the third pushbutton switch 9 or/and a press of a spring member (not shown) energizing the pushbutton 9b. The operation member 2 is tilted by the small tilt operation power.

When the press to the second icon 2b is removed, the operation member 2 returns to its original position parallel to the upper case 1 as in the case with the first icon 2a.

As a third tilt operation, when the third icon 2c (third tilt position) indicating a trunk open indication symbol drawn on the operation member 2 is pressed, the operation member 2 is tilted in a direction of the third icon 2c.

By this tilt operation, the first protrusion 2e of the operation member 2 operates the first pushbutton switch 5 via the first pressing part 3d of the elastic cover 3. The tilt operation power at this time is operation power caused by distortion at one location of the elastic cover 3 and pressure opposing a press of a spring movable contact (not shown) of the first pushbutton switch 5 or/and a press of a spring member (not shown) energizing the pushbutton 5b. The operation member 2 is tilted by the small tilt operation power as are the above described cases.

When the press to the third icon 2c is removed, the operation member 2 returns to its original position parallel to the upper case 1 as in the case with the first icon 2a.

As a fourth tilt operation, when the fourth icon 2d (fourth tilt position) indicating a panic operation indication symbol drawn on the operation member 2 is pressed, the operation member 2 is tilted in a direction of the fourth icon 2d.

By this tilt operation, the second protrusion 2f and the third protrusion 2g of the operation member 2 operate the two pushbuttons switches, the second pushbutton switch 8 and the third pushbutton switch 9 at the same time via the second pressing part 3e and the third pressing part 3f of the elastic cover 3. The tilt operation power at this time is operation power caused by distortion at two locations of the elastic cover 3 and pressure opposing a press of the spring movable contacts (not shown) of the second and third pushbutton switches 8 and 9 or/and a press of the spring members (not shown) energizing the pushbutton buttons 8b and 9b. The operation member 2 is tilted by the great tilt operation power.

That is, the tilt operation power in the fourth tilt operation is greater than the tilt operation power in the first, second, and third tilt operations, and an operation power increasing means is constituted by distortion in two locations of the elastic cover 3, and the second and third pushbutton switches 8 and 9.

In other words, the four-direction switch device is constructed so that the fourth tilt operation of the operation member 2 for panic operation requires greater tilt operation power than the tilt operation power in the above described first, second, and third tilt operations, to prevent careless fourth tilt operations.

When the press to the fourth icon 2c is removed, the operation member 2 returns to its original position parallel to the upper case 1 as in the case with the first icon 2a. Thus, the four-direction switch device is constructed to be capable of tilt operations in four directions and a return operation.

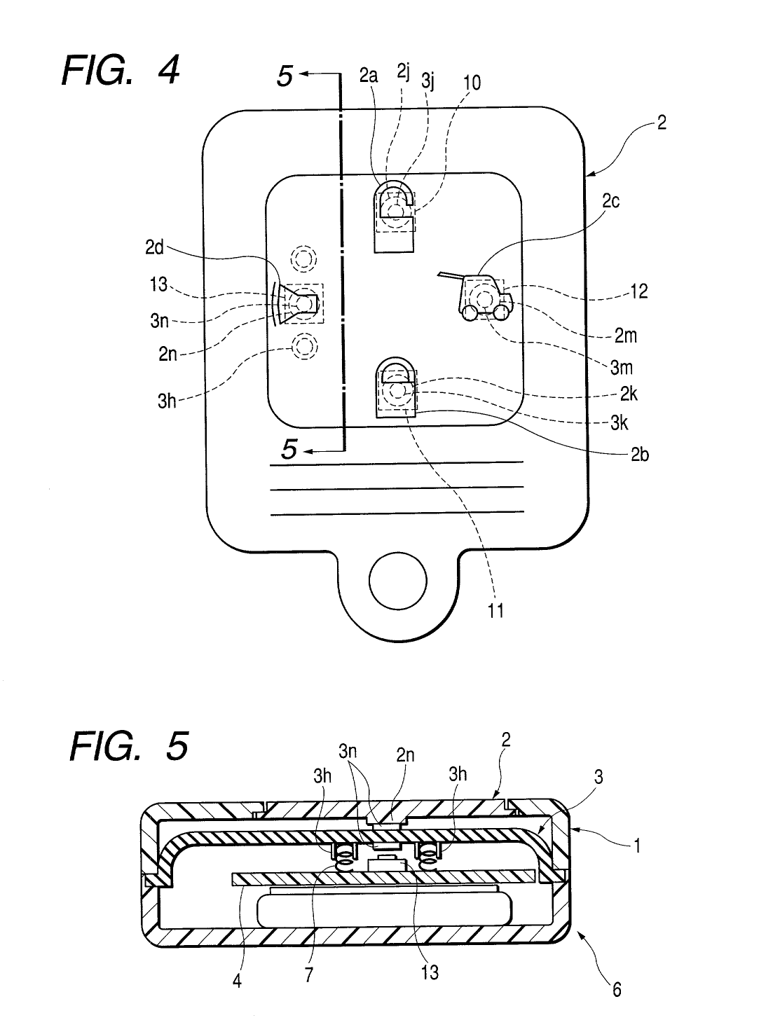

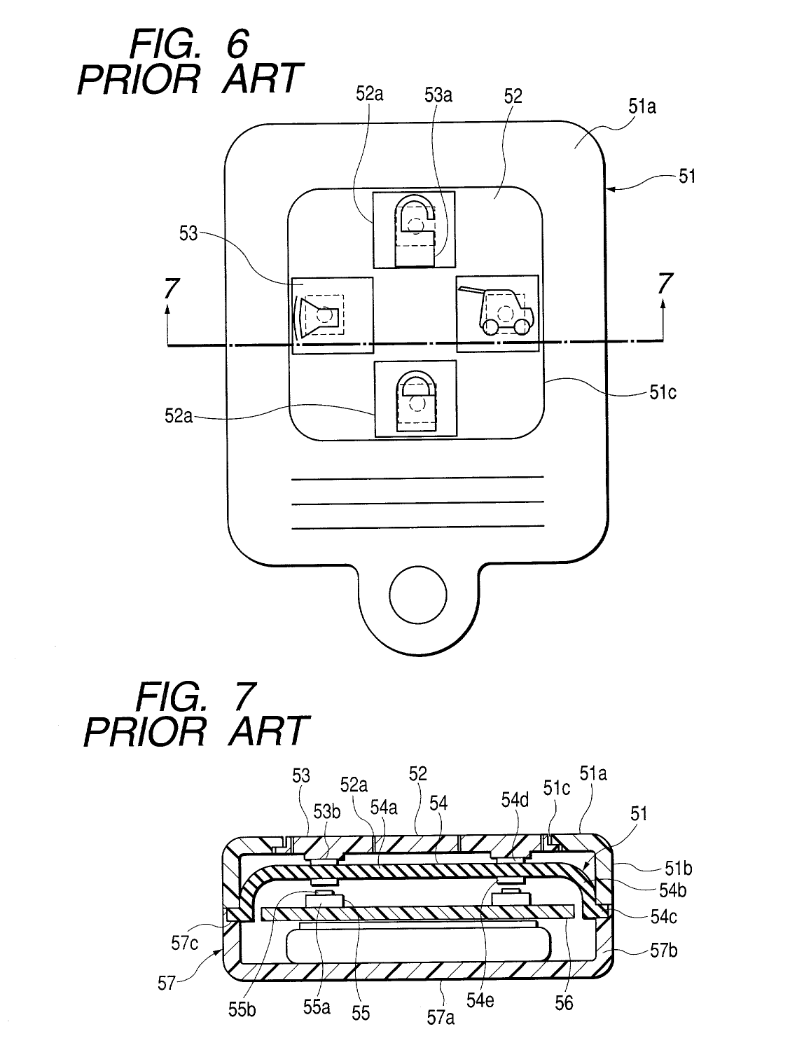

The following explains drawings on a second embodiment of the four-direction switch device of the present invention. FIG. 4 is a plan view showing a second embodiment of the four-direction switch device of the present invention. FIG. 5 is a sectional view taken along the line 5-5 of FIG. 4.

It is understood that components identical to components of the four-direction switch device of the first embodiment are identified by the same reference numerals, and a description of them is omitted.

Hereinafter, a description is made of differences between the second and first embodiments of the four-direction switch device.

An operation member 2 has first, second, third, and fourth protrusions 2j, 2k, 2m, and 2n respectively formed at positions on a back face thereof that are opposite to first, second, third, and fourth icons 2a, 2b, 2c, and 2d.

An elastic cover 3 has first, second, third, and fourth pressing parts 3j, 3k, 3m, and 3n respectively formed at positions that are opposite to the first, second, third, and fourth protrusions 2j, 2k, 2m, and 2n of the operation member 2. A pair of nearly cylindrical tubes 3h are formed at opposite positions with the fourth pressing part 3n sandwiched.

First, second, third, and fourth pushbutton switches 10, 11, 12, and 13 are mounted on a printed wiring board 4 by a proper means such as soldering at four locations thereof that are respectively opposite to the first, second, third, and fourth pressing parts 3j, 3k, 3m, and 3n of the elastic cover 3.

The fourth pushbutton switch 13 is disposed to be opposite to the fourth icon 2d indicating a panic operation indication symbol.

Elastic coil springs 7, spirally formed, are placed within the tubes 3h of the elastic cover 3 and elastically pressed between the elastic cover 3 and the printed wiring board 4.

That is, the elastic coil spring 7 is placed in the vicinity of the fourth icon 2d for panic operation so that, when a position of the operation member 2 in which the fourth icon 2d is drawn is pressed, the operation member 2 is tilted in a direction of the fourth icon 2d, and the tilt operation causes the elastic cover 3 to be pressed against elastic force of the elastic coil spring 7. This means that the operation member 2 is tilted with a great tilt operation power.

The tilt operation power in the fourth tilt operation requires greater tilt operation power than the tilt operation power in the above described first, second, and third tilt operations because other tilt operations would not operate the elastic coil spring 7. An operation power increasing means is constituted by the two elastic coil springs 7.

When the press to the fourth icon 2d is removed, the operation member 2 returns to its original position parallel to the upper case 1 as in the case with the first icon 2a. Thus, the four-direction switch device is constructed to be capable of tilt operations in four directions and a return operation.

Although, in the first embodiment, the operation power increasing means is constituted by distortion in two locations of the elastic cover and the operation power to operate two pushbutton switches, the present invention is not limited to this configuration, and only distortion operation of the elastic cover or only press operation of two pushbutton switches may be used as the operation power increasing means.

Although, in the second embodiment, two elastic coil springs are used to constitute the operation power increasing means, the present invention is not limited to this configuration, and one elastic coil spring may be used or an elastic member may be placed.

In the four-direction switch device of the present invention, the operation member can tilt to first and second tilt positions that are opposite to each other with respect to a tilt center, and third and fourth tilt positions that are orthogonal to the first and second tilt positions and are opposite to each other with respect to the tilt center, and has an operation power increasing means for producing greater operation power for a tilt to the fourth tilt position than for tilts to the first, second, and third tilt positions during tilt operations on the operation member. With the construction, since tilt operation power to one tilt position of the operation member is grater than tilt operation power to other three tilt positions, there is a difference in the magnitude of tilt operation power, so that a four-direction switch device almost free of careless operations can be provided which can explicitly tell the operator a tilt position requiring the great tilt operation power.

The four-direction switch device of the present invention has first, second, and third pushbutton switches operated by the operation member, wherein one pushbutton switch is operated in each of the first, second, and third tilt positions, two of the pushbutton switches are operated in the fourth tilt position, and the operation power increasing means is constituted by operation power with which the two pushbutton switches are operated. With the construction, since the four-direction switch device can be configured with three pushbutton switches, the number of parts can be reduced and the inexpensive four-direction switch device can be provided in which the operation power increasing means is constituted by operation power with which the two pushbutton switches are operated.

The four-direction switch device of the present invention is constructed so that a panic operation is performed by operating the operation member for the fourth tilt operation, which is provided with the operation power increasing means. With this construction, a four-direction switch device almost free of careless panic operations can be provided.

What is claimed is:

1. A four-direction switch device, comprising:
a case;
plural pushbutton switches housed in the case; and
one operation member that is supported by the case to be tiltable in four directions and operates the pushbutton switches by tilt operations in the respective directions,
wherein the operation member can tilt to first and second tilt positions that are opposite to each other with respect to a tilt center, and third and fourth tilt positions that are orthogonal to the first and second tilt positions and are opposite to each other with respect to the tilt center, and
wherein the operation member has an operation power increasing means for producing greater operation power for a tilt to the fourth tilt position than for tilts to the first, second, and third tilt positions during tilt operations on the operation member.

2. The four-direction switch device according to claim 1 which has first, second, and third pushbutton switches operated by the operation member,
wherein one pushbutton switch is operated in each of the first, second, and third tilt positions,
wherein two of the pushbutton switches are operated in the fourth tilt position, and
wherein the operation power increasing means is constituted by operation power with which the two pushbutton switches are operated.

3. The four-direction switch device according to claim 2,
wherein the first pushbutton switch is placed on a line passing through the tilt center at a side of the third tilt position,
wherein the second pushbutton switch is placed in a middle position between the first tilt position and the fourth tilt position,
wherein the third pushbutton switch is placed in a middle position between the second tilt position and the fourth tilt position,
wherein when the operation member is operated to tilt to the fourth tilt position, the two second and third pushbutton switches are operated at the same time, and
wherein the operation power increasing means is constituted by operation power with which the two second and third pushbutton switches are operated.

4. The four-direction switch device according to claim 2,
wherein each pushbutton switch is constructed to operate by dint of pressure opposing a press of a spring movable contact or/and a press of a spring member energizing the pushbutton, and
wherein the operation power increasing means is constituted by the pressure against the two pushbutton switches.

5. The four-direction switch device according to claim 2,
wherein an elastic cover made from rubber is disposed to cover the pushbutton switches between the operation member and the plural pushbutton switches,
wherein the pushbutton switches are operated via the elastic cover by tilting the operation member, and
wherein during a fourth tilt operation, the elastic cover is formed to distort in at least two locations which are opposite to the two pushbutton switches, to use the distortion of the elastic cover as the operation power increasing means.

6. The four-direction switch device according to claim 1, wherein a panic operation is performed by operating the operation member for the fourth tilt operation, which is provided with the operation power increasing means.
